(19) United States
(12) Patent Application Publication
(10) Pub. No.: US 2022/0185492 A1
(43) Pub. Date: Jun. 16, 2022

(54) AIRCRAFT ENGINE PYLON AFT AERODYNAMIC FAIRING

(71) Applicant: Airbus Operations SAS, Toulouse (FR)

(72) Inventors: Elodie DELON, PINS-JUSTARET (FR); Yannick CADORET, VELLIZY-VILLACOUBLAY (FR)

(21) Appl. No.: 17/550,984

(22) Filed: Dec. 14, 2021

(30) Foreign Application Priority Data
Dec. 15, 2020 (FR) 2013254

(51) Int. Cl. B64D 27/26; B64D 29/00

(52) U.S. Cl. CPC B64D 27/26; B64D 2027/266; B64D 29/00

(57) ABSTRACT

An aft aerodynamic fairing of an aircraft engine pylon including at least two side panels, wherein each side panel is made of titanium or of titanium alloy and wherein at least one anti-oxidation protective layer, including a layer composed of a chemically inert ceramic material is deposited on the external faces of each side panel that, when the aircraft engine pylon is in use, are in contact with an aerodynamic flow.

### CROSS-REFERENCES TO RELATED APPLICATIONS

This application claims the benefit of the French patent application No. 2013254 filed on Dec. 15, 2020, the entire disclosures of which are incorporated herein by way of reference.

### FIELD OF THE INVENTION

The invention concerns an aircraft engine pylon aft aerodynamic fairing.

### BACKGROUND OF THE INVENTION

In known manner, a pylon for attaching an aircraft engine includes a rigid structure known as the primary structure (transmission of forces), attachment means disposed between the engine and the rigid structure (motor attachments), and a plurality of secondary structures for the segregation and the retention of the systems, while supporting aerodynamic fairing elements.

The secondary structures include the aft aerodynamic fairing, also known as the aft pylon fairing “APF”, which has a plurality of functions among which is noted the formation of a thermal or anti-fire barrier and the formation of aerodynamic continuity between the outlet of the engine and the attachment pylon. This aft fairing generally takes the form of a box section comprising two side panels assembled together by ribs and a thermal protection floor.

By virtue of its position closest to the outlet of the engine, this pylon is subjected to temperatures that can be as high as 600° C., depending on the engines. This is why it is made from a high-performance nickel-based alloy. This material has the advantage of having excellent mechanical strength and good resistance to creep at high temperature, good surface stability and good resistance to corrosion and oxidation. However, this material has the disadvantage of being costly, which penalizes its use on an aircraft where reducing the weight of the aircraft remains a major preoccupation of an aircraft manufacturer.

There is, therefore, at present a great interest in the use of materials of high strength and low density suitable for use at high temperatures such as titanium and titanium alloys. These titanium alloys, already used in the aeronautical field, could replace the nickel alloy for manufacturing the aft aerodynamic fairing. A titanium alloy of type Ti-6Al-4V or Ti-6242 is the ideal candidate for this fairing because its mechanical properties and its manufacturing cost are compatible with the use under consideration.

However, a serious limitation on the use of these titanium alloy in this kind of application is the loss of strength caused by oxidation of this material. In fact, this type of alloy must be used for elements subjected to temperatures not exceeding 350° C. Now, this aft aerodynamic fairing can be regularly subjected to temperatures on the order of 600° C., which accelerates the oxidation of the titanium alloy, thereby favoring the diffusion of oxygen into the alloy. This diffusion of oxygen into the titanium alloy favors the formation of a fragile layer close to the surface of the fairing. This fragile layer, rich in oxygen, oxidizes the surface of the fairing, leading to its premature deterioration caused by mechanisms such as cracks, for example.

To take such phenomena into account, dimensions of such elements produced by the design office apply a weighting of the mechanical specifications that can be as high as 40%. Consequently, these fairings must be inspected and changed regularly, inducing high maintenance costs.

Various studies have shown that protection on the titanium would reduce the diffusion of oxygen into the metal so as to slow down the formation of the fragile layer rich in oxygen, which would reduce the deterioration of the mechanical characteristics of the titanium alloy.

The document U.S. Pat. No. 5,098,540 describes a coating composed of a continuous film of chromium atoms deposited by the physical vapor phase deposition (PVD) process onto titanium in order to offer protection against substantial oxidation up to approximately 900° C. However, at the temperatures of use of the aft aerodynamic fairing, this coating has the disadvantage of diffusing into the titanium alloy, modifying the internal microstructure of the alloy and degrading the mechanical properties of the alloy.

### SUMMARY OF THE INVENTION

An object of the present invention is to resolve some or all of the disadvantages of the prior art referred to hereinabove.

The invention concerns an aft aerodynamic fairing of an aircraft engine pylon including at least two side panels, characterized in that each side panel is made of titanium or of titanium alloy, and in that at least one anti-oxidation protective layer including a layer composed of a chemically inert ceramic material is deposited on the external faces of each side panel that, in use, are in contact with an aerodynamic flow.

This anti-oxidation protective layer has the following advantages: it has good thermal and chemical stability at temperatures up to 700° C., which is well above the temperatures to which the side panels of the fairing will be subjected. Thus, it protects the panels against the diffusion of oxygen into the titanium alloy and limits oxidation thereof, also combating possible contamination thereof by fluids. The weighting when sizing the fairing is significantly reduced by this, thereby reducing maintenance costs. This protection layer also offers protection against erosion and good impact resistance.

According to particular embodiments of the invention:

the anti-oxidation protective layer is composed of a stack of at least two layers of chemically inert ceramic material, between which is deposited at least one intermediate metal layer,

the intermediate metal layer is chosen from the following materials: chromium, titanium, aluminum,

the external face of each side panel includes a plurality of anti-oxidation protective layers arranged in pairs between which a metal layer is interleaved,

the anti-oxidation protective layer has a thickness between 1 μm and 50 μm inclusive,

the anti-oxidation protection layer has a thickness on the order of 20 μm,

the chemically inert ceramic material is chosen from the following materials: Al2O3, TiO2, Cr2O3, AlCrO, TiN, AN, AlCrN, TiAlN, AlTiN, CrN.

The invention concerns a method of protection against oxidation of an external face of a panel used for the assembly of an aft aerodynamic fairing, made of titanium or of titanium alloy, the method being noteworthy in that an anti-oxidation protective layer is deposited on the external face of each side panel by a physical vapor phase deposition process, this process including the following steps:

deposition of the side panel in a vacuum enclosure,

evaporation of a target material,

addition in parallel of a reactive gas,

formation of the chemically inert ceramic material constituted of the chemical reaction between the evaporated target material and the reactive gas,

deposition of the anti-oxidation protective layer including a layer composed of the chemically inert ceramic material on the surface of the panel.

The invention also concerns a method for protection against oxidation of an external face of a panel used for the assembly of an aft aerodynamic fairing, made of titanium or of titanium alloy, this method being noteworthy in that an anti-oxidation protective layer composed of a chemically inert TiO2 ceramic material is deposited on the external face of each side panel by an anodization deposition process, this process including the following steps:

immersion of the side panel in an acid electrolyte bath,

application to the side panel of a voltage between 5 V and 30 V inclusive,

creation by electrolysis of an anti-oxidation protective layer including a layer composed of the chemically inert ceramic material on the surface of the panel,

retaining the side panel in the acid electrolyte bath until a thickness of the anti-oxidation protective layer between 1 μm and 50 μm inclusive is obtained.

### BRIEF DESCRIPTION OF THE DRAWINGS

The invention will be better understood on reading the following description given by way of example only and with reference to the appended drawings, in which:

FIG. 1 represents an aircraft engine attachment pylon;

FIG. 2 represents in section the structure of an aerodynamic fairing according to a first embodiment of the invention;

FIG. 3 represents in section the structure of an aerodynamic fairing according to a second embodiment of the invention;

FIG. 4 represents in section the structure of an aerodynamic fairing according to a third embodiment of the invention.

### DETAILED DESCRIPTION OF THE PREFERRED EMBODIMENTS

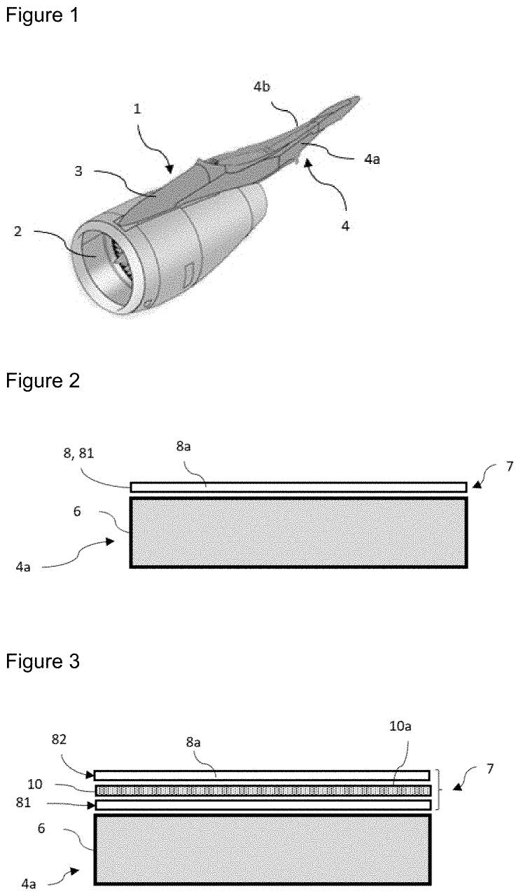

In FIG. 1 there is represented a pylon 1 for attaching an aircraft engine 2, which pylon includes a rigid structure known as the primary structure (not represented) for the transmission of forces, attachment means (not represented) disposed between the engine and the rigid structure, known as engine attachments, and a plurality of secondary structures assuring the segregation and the retention of the systems, while supporting aerodynamic fairing elements (front fairing 3 and aft fairing 4).

The secondary structures include the aft aerodynamic fairing 4, also known as the aft pylon fairing (APF), which has a plurality of functions among which note the formation of a thermal or anti-fire barrier and the formation of aerodynamic continuity between the outlet of the engine 2 and the attachment pylon 1. This aft fairing 4 generally takes the form of a box section comprising two side panels 4a, 4b assembled together by ribs and a thermal protection floor (not represented). These side panels 4a, 4b have an external face that, in use, is in contact with the aerodynamic flow.

According to the invention, the side panels 4a and 4b are made of titanium alloy (for example Ti-6Al-4V or Ti-6242) and no longer of nickel. To be more precise, as indicated in FIG. 2 and in accordance with a first embodiment, the external face of the panel 4a (respectively 4b) includes a layer 6 of titanium alloy on which is deposited an anti-oxidation protective layer 7 composed of a layer 8, 81 of a chemically inert ceramic material 8a. The protective layer 7 will generate a barrier conformed to limit the diffusion of the oxygen atoms into the panels 4a, 4b of the fairing 4 generated by the rise in temperature of the environment to which the side panels 4a, 4b of the fairing are subjected. In fact, the chemically inert materials have virtually no chemical reactivity.

The panels 4a and 4b therefore have good thermal and chemical stability at temperatures that can be as high as 600° C., depending on the engines. These panels are therefore protected against corrosion, greatly reducing their contamination by fluids. The fatigue behavior of these panels 4a and 4b is improved, the weighting for their dimensions being significantly reduced. The maintenance costs are reduced accordingly.

Referring to FIG. 3, there is represented a second embodiment in which the protective layer 7 is composed of a stack of at least two layers 8 of chemically inert ceramic material 8a, between which is deposited at least one metal intermediate metal layer 10. In this embodiment, the first layer 81 deposited on the external face of the panels 4a, 4b, and the last layer 82 in contact with the aerodynamic flow are layers 8 composed of a chemically inert ceramic material 8a in order to assure effective protection against the diffusion of oxygen into the panels 4a and 4b. The intermediate metal layer 10 has the advantage of improving the overall stiffness of the protective layer 7. The resulting layer has improved resistance to impacts and to erosion. As in the previous embodiment, the panels 4a and 4b have good thermal and chemical stability.

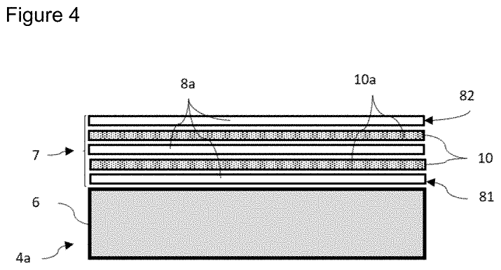

According to a variant of the second embodiment represented in FIG. 4, the external face of each side panel 4a, 4b includes an anti-oxidation protective layer 7 composed of a plurality of layers 8 arranged in pairs between which an intermediate metal layer 10 is interleaved. There is, therefore, seen an alternating stack of layers 8 and of intermediate metal layers 10. In this figure, the protective layer 7 is composed of three layers 8 of inert material 8a and two intermediate metal layers 10. Without departing from the scope of the invention, repeating this stacking may be envisaged so as to obtain a protective layer 7 composed of a plurality of layers 8 of inert material 8a and a plurality of intermediate metal layers 10. In this variant embodiment, the first layer 81 deposited on the external face of the panels 4a, 4b and the last layer 82 in contact with the aerodynamic flow are layers 8 composed of a chemically inert ceramic material 8a in order to assure effective protection against the diffusion of oxygen into the panels 4a and 4b.

Physical vapor phase deposition of a coating has been widely adopted for improving the resistance to friction of mechanical parts and to combat the wear of cutting tools. These coatings deposited by physical vapor phase deposition are hard and resistant to wear on cutting tools, reducing their production costs and improving their productivity.

Now, in the particular case of the fairing 4, improving its strength is not aimed at because it is overall subjected only to the aerodynamic flow, unlike mechanical parts that rub and cutting tools that move in an environment that is more constraining from the friction point of view.

To the contrary, the deposition of a chemically inert ceramic material 8a deposited by physical vapor phase deposition will generate a barrier conformed to limit the diffusion into the panels 4a, 4b of the fairing 4 of the oxygen atoms generated by the rising temperature of the environment to which the side panels of that fairing 4 are subjected.

The invention also concerns a method of manufacture in which the protective layer 7 of the three embodiments described above is deposited by physical vapor phase deposition.

To produce the protective layer 7 of the first embodiment a layer 8, 81 composed of a chemically inert ceramic material 8a is deposited by physical vapor phase deposition on the external face of the side panels 4a, 4b. In use, the layer 8, 81 is in contact with the aerodynamic flow.

In order to produce an anti-oxidation protective layer 7 in accordance with the second embodiment, a first protective layer 8, 81 composed of a chemically inert ceramic material 8a is deposited by physical vapor phase deposition on the external face of the side panels 4a, 4b. An intermediate metal layer 10 is then deposited on this layer 81 by physical vapor phase deposition. Finally, a last layer 8, 82 is deposited by physical phase deposition on the surface of that intermediate metal layer 10. This latter layer 82 is a layer 8 composed of a chemically inert ceramic material 8a in order to assure efficient protection against the diffusion of oxygen into the panels 4a and 4b. In use, this last layer 82 is in contact with the aerodynamic flow.

In order to produce an anti-oxidation protective layer 7 in accordance with the variant of the third embodiment, a first protective layer 8, 81 composed of a chemically inert ceramic material 8a is deposited by physical vapor deposition on the external face of the side panels 4a, 4b. A first intermediate metal layer 10 is deposited on this layer 8, 81 by physical vapor phase deposition. A second layer 8 of material 8a is deposited by physical vapor phase deposition on the surface of the first intermediate metal layer 10. Then, a second metal intermediate layer 10 is deposited by physical vapor deposition on that second layer 8 of material 8a. Finally, a last layer 8, 82 is deposited on the surface of that second intermediate metal layer 10 by physical vapor phase deposition. As before, this last layer 82 is a layer 8 composed of a chemically inert ceramic material 8a in order to assure effective protection against the diffusion of oxygen into the panels 4a and 4b. In use, this last layer 82 is in contact with the aerodynamic flow.

In order to produce a physical vapor phase deposit, the panel 4a, 4b is placed in an enclosure under vacuum. The target material (aluminum, chromium, titanium) that is used is the material entering into the composition of the chemically inert ceramic material 8a. That target material is evaporated by ionized gas bombardment, for example. As a function of the mode of evaporation of the target material, the evaporation temperature can be from 70° C. to 600° C. In parallel with this a reactive gas (oxygen or nitrogen) is added in order for it to mix with the metal vapor created from the target material used. This gas forms with the metal vapor created the chemically inert ceramic material 8a. The chemically inert ceramic material 8a is therefore the result of the chemical reaction between the evaporated target material (chromium, titanium or aluminum) and the reactive gas (oxygen or nitrogen). This material 8a is deposited on the surface of the side panel 4a, 4b in order to form the layer 8 of the anti-oxidation protective layer 7.

In accordance with this physical vapor phase deposition process, the chemically inert ceramic material 8a is chosen from the following materials: Al2O3, TiO2, Cr2O3, AlCrO, TiN, AN, AlCrN, TiAlN, AlTiN, CrN.

In accordance with this same physical vapor phase deposition process, the intermediate metal layer 10 may be chosen from the following materials 10a without this list being limiting on the invention: chromium, titanium or aluminum.

This metal layer 10 is preferably chosen to be the same material as the evaporated target material used to generate the ceramic material 8a.

In accordance with a second process for executing the invention, a single protective layer 7 composed of a layer 8 of material 8a is deposited by an anodization process on the external face of the side panels 4a and 4b. In accordance with this second method of executing the invention the chemically inert ceramic material 8a is composed of a layer of TiO2.

In accordance with this second process the side panel 4a, 4b is immersed in an acid electrolyte bath, for example a bath of dilute sulfuric acid. The side panel is connected to the anode of a voltage generator. A voltage usually between 5 V and 30 V inclusive is delivered and applied to the side panel 4a, 4b. The reaction of electrolysis in an acid medium will lead to the creation of a layer of titanium oxide (TiO2) on the surface of the panel 4a, 4b. The panel 4a, 4b remains in the acid electrolyte bath until the required thickness of the anti-oxidation protective layer 7 is obtained.

The supplementary advantage of physical vapor phase deposition or deposition by anodization is to be able to deposit thin layers of the material 8a. The objective of that layer not being to act as a thermal barrier, it is not necessary for the anti-oxidation protective layer 7 to be very thick. This would have the disadvantage of increasing the weight of the fairing 4 without being any more beneficial against oxidation. In fact, the presence of the chemically inert ceramic material 8a acts as a physical barrier that constitutes an obstacle to the atoms of oxygen, limits their diffusion into the titanium alloy 6 and greatly slows down the corrosion of that material. Consequently, the thickness of the anti-oxidation protection layer 7 in accordance with any of the embodiments described above can vary between 1 μm and 50 μm. It will preferably be on the order of 20 μm.

The anti-oxidation protective layer 7 being thin, it has a high density that enables it also to offer protection against erosion as well as good impact resistance.

Accordingly, whichever process is used to deposit the anti-oxidation protective layer 7 composed of at least one layer 8 of chemically inert material 8a, that material 8a is introduced at the molecular level into the spaces left free by the atoms of titanium alloy, blocking those spaces, which prevents the atoms of oxygen generated by the rise in temperature nearby to diffuse into the layer of titanium alloy 6. The material 8a being intrinsically inert, it has a chemical and thermal stability that will be neither modified nor degraded by the external conditions which it will encounter: rise of temperature, aerodynamic flow, . . . .

Accordingly, whether deposition is effected by physical vapor phase deposition or by an anodization process, the limitation of the diffusion of the oxygen atoms into the titanium alloy 6 of the side panels 4a and 4b is assured in a durable manner

In this way, the panels 4a and 4b in accordance with the various embodiments of the invention have good thermal and chemical stability at temperatures that may be as high as 600° C., as a function of the engines. Consequently, these panels are protected against corrosion, greatly reducing their contamination by fluids. The fatigue behavior of these panels 4a and 4b is improved, the weighting for the dimensions thereof being significantly reduced. Maintenance costs are reduced accordingly.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An aft aerodynamic fairing of an aircraft engine pylon including:
at least two side panels,
each side panel comprising titanium or a titanium alloy,
wherein at least one anti-oxidation protective layer including a layer composed of a chemically inert ceramic material is deposited on external faces of each side panel that are configured to be in contact with an aerodynamic flow when the aircraft engine pylon is in use.

2. The fairing according to claim 1, wherein the at least one anti-oxidation protection layer is composed of a stack of at least two layers of chemically inert ceramic material between which is deposited at least one intermediate metal layer.

3. The fairing according to claim 2 wherein the intermediate metal layer is chosen from the following materials: chromium, titanium, aluminum.

4. The fairing according to claim 3 wherein the external face of each side panel includes an anti-oxidation protective layer composed of a plurality of anti-oxidation protective layers arranged in pairs between which a metal layer is interleaved.

5. The fairing according to claim 4, wherein the at least one anti-oxidation protective layer has a thickness between 1 μm and 50 μm inclusive.

6. The fairing according to claim 5, wherein the anti-oxidation protection layer has a thickness of the order of 20 μm.

7. The fairing according to claim 1, wherein the chemically inert ceramic material is chosen from the following materials: Al2O3, TiO2, Cr2O3, AlCrO, TiN, AN, AlCrN, TiAlN, AlTiN, CrN.

8. A method of protection against oxidation of an external face of a panel used for an assembly of an aft aerodynamic fairing according to claim 1, made of titanium or of titanium alloy, wherein the at least one anti-oxidation protective layer is deposited on the external faces of each side panel by a physical vapor phase deposition process, said process including the following steps:
depositing the side panel in a vacuum enclosure,
evaporating a target material,
adding, in parallel, a reactive gas,
forming the chemically inert ceramic material constituted of a chemical reaction between the evaporated target material and the reactive gas,
depositing the anti-oxidation protective layer including a layer composed of the chemically inert ceramic material on a surface of the panel.

9. A method of protection against oxidation of an external face of a panel used for assembly of an aft aerodynamic fairing according to claim 1, made of titanium or of titanium alloy, wherein the at least one anti-oxidation protective layer composed of a chemically inert titanium oxide ceramic material is deposited on the external faces of each side panel by an anodization deposition process, said process including the following steps:
immersing the side panel in an acid electrolyte bath,
applying the side panel of a voltage between 5 V and 30 V inclusive,
creating by electrolysis an anti-oxidation protective layer including a layer composed of the chemically inert ceramic material on a surface of the panel,
retaining the side panel in the acid electrolyte bath until a thickness of the anti-oxidation protective layer between 1 μm and 50 μm inclusive is obtained.
